(19) United States
(12) Patent Application Publication
(10) Pub. No.: US 2015/0241882 A1
(43) Pub. Date: Aug. 27, 2015

(54) MIXING VALVE

(71) Applicants: Laura Michelle BENDULA-WASSON, Cincinnati, OH (US); Richard James Humason, Cincinnati, OH (US)

(72) Inventors: Laura Michelle BENDULA-WASSON, Cincinnati, OH (US); Richard James Humason, Cincinnati, OH (US)

(21) Appl. No.: 14/634,225

(22) Filed: Feb. 27, 2015

Related U.S. Application Data
(60) Provisional application No. 61/945,510, filed on Feb. 27, 2014.

(51) Int. Cl. G05D 11/03

(52) U.S. Cl. CPC G05D 11/03

(57) ABSTRACT

A mixing valve comprising a valve body having a first end, a second end, and defining a valve chamber between the first end and the second end. A needle element is disposed in the valve chamber, a linear actuator is connected to the needle element, and a first port communicates with the valve chamber for receiving a first fluid. A second port communicates with the valve chamber for receiving a second fluid, and a third port communicates with the valve chamber for dispensing a mixture containing at least some of the first fluid and at least some of the second fluid.

### CROSS-REFERENCE TO RELATED APPLICATION

This application claims the benefit of U.S. Provisional Patent Application No. 61/945,510 filed on Feb. 27, 2014, the disclosures of which are incorporated herein by reference.

### FIELD OF INVENTION

This invention relates generally to a mixing valve having a needle, a linear actuator for moving the needle, a first port for receiving a first fluid, a second port for receiving a second fluid, and a third port for dispensing a mixture of the first fluid and the second fluid.

### BACKGROUND OF THE INVENTION

Needle valves are typically used for regulating the flow of fluids. When mixing multiple fluids, a user typically uses a first needle valve to regulate the flow of a first fluid to a common outlet and a second needle valve to regulate the flow of a second fluid to the common outlet. Provided here is a mixing valve wherein a first fluid and a second fluid are mixed and dispensed with a single valve.

### SUMMARY OF THE INVENTION

This invention relates to a mixing valve comprising a valve body having a first end, a second end, and defining a valve chamber between the first end and the second end, a needle element disposed in the valve chamber, a linear actuator connected to the needle element, a first port communicating with the valve chamber for receiving a first fluid, a second port communicating with the valve chamber for receiving a second fluid, and a third port communicating with the valve chamber for dispensing a mixture containing at least some of the first fluid and at least some of the second fluid.

This invention also relates to a mixing valve comprising a valve body having a first end, a second end, and defining a valve chamber between the first end and the second end, wherein the valve chamber has a first chamber, a second chamber, and a third chamber, a needle element disposed in the valve chamber, a linear actuator connected to the needle element, a first needle seat disposed between the first and third chamber, a second needle seat disposed between the second and third chamber, a first port communicating with the first chamber for receiving a first fluid, a second port communicating with the second chamber for receiving a second fluid, and a third port communicating with the third chamber for dispensing a mixture containing at least some of the first fluid and at least some of the second fluid.

### BRIEF DESCRIPTION OF THE DRAWINGS

FIG. 1 is a section view of a mixing valve of the invention.

FIG. 2 is a side view of a needle element of the mixing valve of FIG. 1.

FIG. 3A is an end view of a needle seat of the mixing valve of FIG. 1.

FIG. 3B is a section view of the needle seat of FIG. 3A.

FIG. 4A is an end view of another needle seat of the mixing valve of FIG. 1.

FIG. 4B is a section view of the needle seat of FIG. 4A.

FIG. 5 is a section view of the mixing valve of FIG. 1 with the needle element in a proximal position.

FIG. 6 is a section view of the mixing valve of FIG. 1 with the needle element in a distal position.

FIG. 7 is a section view of the mixing valve of FIG. 1 with the needle element in a central position.

FIG. 8 is a graph showing an exemplar flow profile of the mixing valve of FIG. 1.

FIG. 9A is an end view of a guide of the invention.

FIG. 9B is a section view of the guide of FIG. 9A.

FIG. 10 is a section view of another embodiment of a mixing valve of the invention.

FIG. 11 is a side view of a needle element of the mixing valve of FIG. 10.

FIG. 12 is a section view and an end view of a needle seat of the mixing valve of FIG. 10.

FIG. 13 is a section view and an end view of another needle seat of the mixing valve of FIG. 10.

FIG. 14 is a section view of the mixing valve of FIG. 10 with the needle element in a proximal position.

FIG. 15 is a section view of the mixing valve of FIG. 10 with the needle element in a distal position.

FIG. 16A is a section view of the mixing valve of FIG. 10 with the needle element in a central position.

FIG. 16B is an enlarged section view of the mixing valve of FIG. 17A.

### DETAILED DESCRIPTION OF THE INVENTION

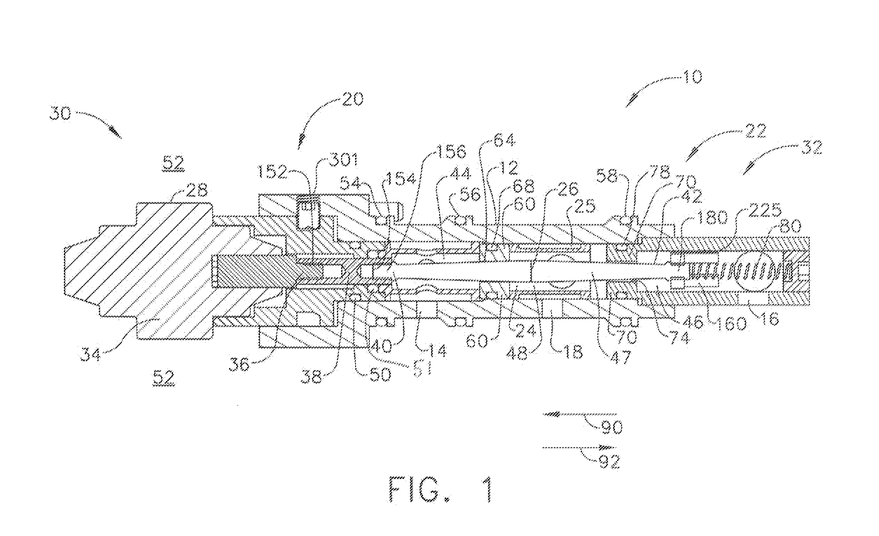

FIG. 1 shows an embodiment of a mixing valve 10 having a first end 30 and a second end 32. The mixing valve 10 has a body 12 having a first port 14, a second port 16, and a third port 18. The body 12 has a first end 20 and a second end 22. The body 12 has a centrally located valve chamber 24 that communicates with the first port 14, the second port 16, and the third port 18. The valve chamber 24 receives a needle element 26. Typically, the valve chamber is cylindrical, as is the needle element, but the valve chamber and needle element may be other shapes also. The body 12 shown in FIG. 1 is for a cartridge type of mixing valve, which would be inserted into a cavity in a valve block (not shown) known to those in the art. Seals 54, 56, and 58 seal the valve body 12 against the cavity walls of the valve block. Other types of valves, such as ported or manifold valves, may also be made using the embodiment described herein. The mixing valve can be used to mix various types of fluids, such as liquids or gases.

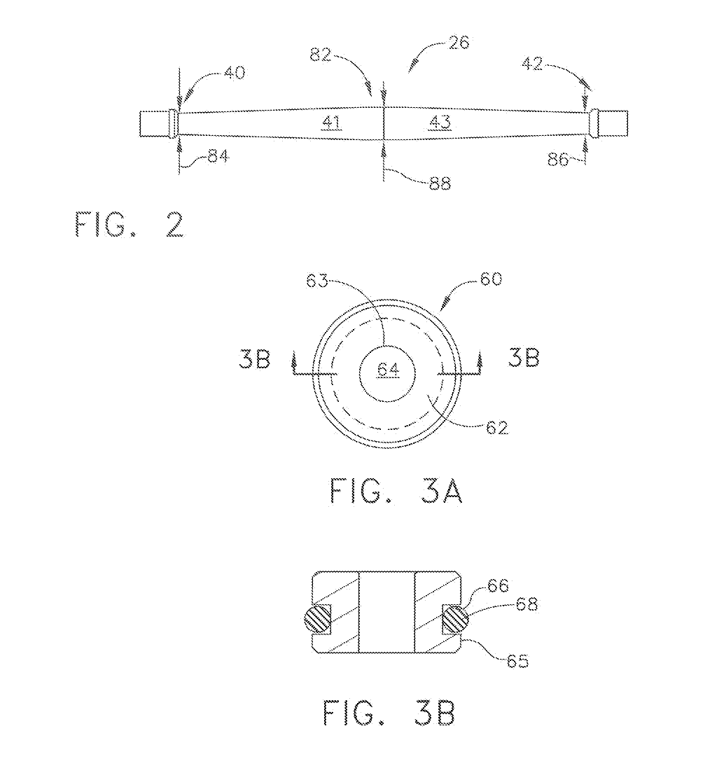

FIG. 2 shows an enlarged view of the needle element 26. The needle element has a first end 40, a second end 42, a tapered first portion 41, a tapered second portion 43, and a central section 82. The first end 40 has a diameter 84, the second end 42 has a diameter 86, and the central section 82 has a diameter 88. Typically, the diameter 84 of the first end 40 and the diameter 86 of the second end 42 are less than the diameter 88 of the central section 82. Thus, the needle element 26 tapers from a larger diameter at the central section 82 to a smaller diameter at the first end 40 and the second end 42.

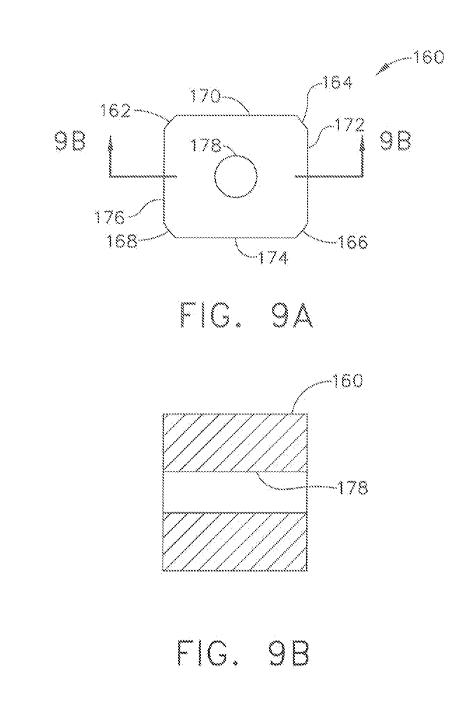

The needle 26 may be made from a single piece or it may be made of two pieces, with the first portion 41 being one piece and the second portion 43 being another piece. If made of two pieces, the portions are typically joined at the central section 82. The pieces may be rigidly joined, such as by one portion having a male thread and one portion having a female thread, or they may be loosely joined to allow movement between the first portion 41 and the second portion 43. One method of loosely joining the first and second portion is to provide one portion with a pin and the other portion with an oversized hole with an internal diameter larger than the external diameter of the pin to receive the pin. Alternatively, the first portion 41 and second portion 43 may be butted together. If they are loosely joined, a spring 80 (discussed later) biases the second portion 43 against the first portion 41. By loosely joining the first portion 41 to the second portion 43, the first portion will self-align to an orifice 64 (described later) and the second portion will self-align to an orifice 74 (described later). The self-alignment can compensate for a condition in which the orifices are not aligned or do not share a common central axis 47. The second end 42 of the needle 26 is connected to a guide 160 shown in FIGS. 9A and 9B. The guide 160 has edges 162, 164, 166, and 168 that ride against an outer surface 225 to maintain alignment of the second portion 43. Truncated sides 170, 172, 174, and 176 allow fluid to pass between the guide 160 and the outer surface 225. In one embodiment, a female thread 178 is provided in the guide 160 for connecting the guide to a male threaded shaft 180 located on the second end 42 of the needle 26. Other methods, such as a press fit, may be used to connect the second end 42 to the guide 160.

The mixing valve 10 has a linear actuator 28 mounted to the first end 20 of the valve body 12. In the one embodiment, the liner actuator is a stepper motor 34 that drives a male threaded shaft 36, but other types of linear actuators, such as servo motors, may be used. A coupling 38 connects the shaft 36 to a first end 40 of the needle element. The coupling may include female threads 152 for receiving the male threaded shaft 36 of the linear actuator and female threads 154 for receiving a male threaded shaft 156 of the first end 40 of the needle element 26. Other methods for connecting the coupling to the linear actuator and the needle, such as a press fit, may also be used. Alternatively, the needle may be connected directly to the linear actuator. Seals 50 and 51 isolate the valve chamber 24 from atmosphere 52 to prevent fluid in the valve chamber 24 from leaking into the atmosphere 52. A spring 80, typically in compression and communicating with a second end of the needle element 26, biases the needle element against the coupling 38. The linear actuator 28 moves the needle in the direction of arrows 90 and 92 to a predetermined position, depending on the desired fluid mix, explained in greater detail later.

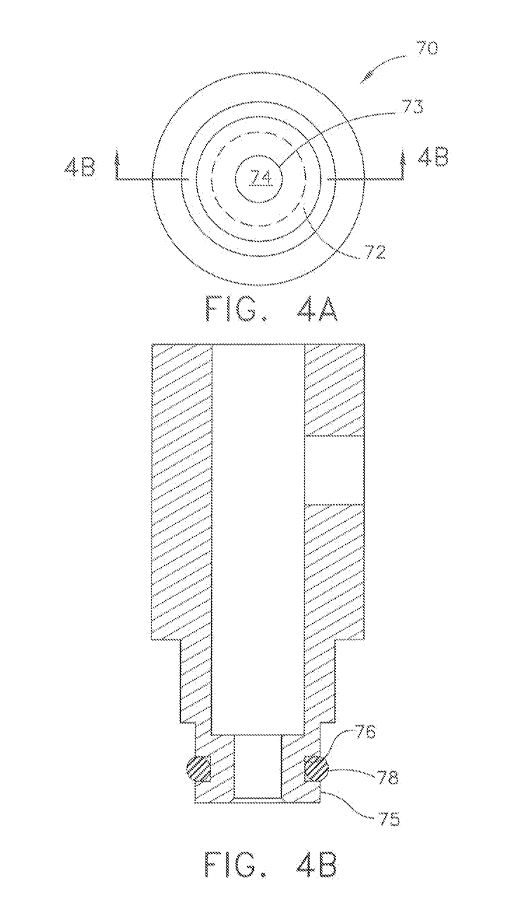

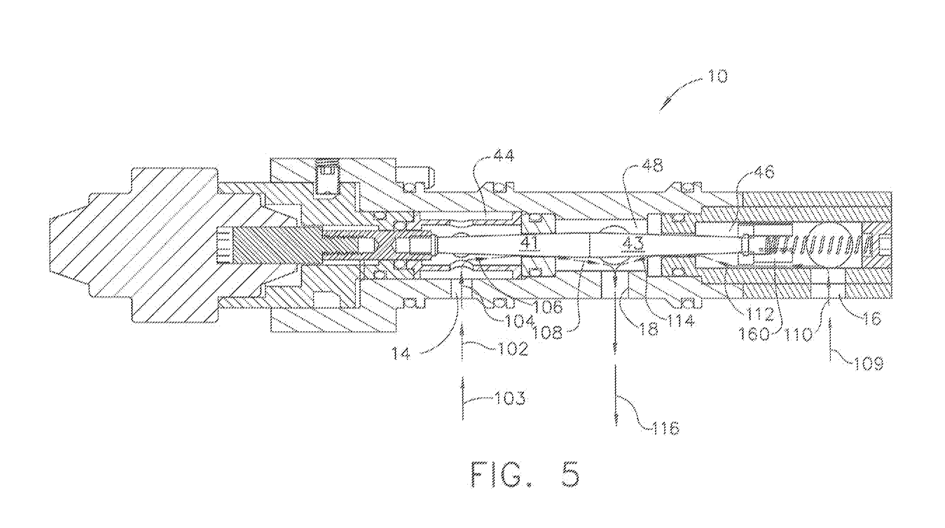

A first needle seat 60 and a second needle seat 70 are located in the valve chamber 24. As shown in FIGS. 1, 3A, 3B, 4A and 4B, the needle seats 60 and 70 have ring sections 62 and 72, respectively, that define orifices 64 and 74, respectively. The orifices 64 and 74 have inside faces 63 and 73, respectively. Grooves 66 and 76 in outer faces 65 and 75 accommodate seals 68 and 78 for sealing the outer faces 65 and 75 against an outer surface 25 of the valve chamber 24. Location of the needle seats 60 and 70 in the valve chamber create a first chamber 44, a second chamber 46, and a third chamber 48. The needle element 26 passes through the orifices 64 and 74.

FIG. 5 shows the mixing valve 10 with the needle element 26 in a position with the first end 40 most proximal the linear actuator 28. A first fluid 103 indicated by arrows 102, 104, 106, and 108 flows in a first port 14, enters the first chamber 44, and passes through the orifice 64 of the first needle seat 60 between the tapered first portion 41 of the needle element and the inside face 63 of the first orifice 64 and enters the third chamber 48. A second fluid 109 indicated by arrows 110, 112, and 114 passes through second port 16, enters the second chamber 46, and passes through the orifice 74 of the second needle seat 70 between the tapered portion 43 of the needle element and the inside face 73 of the second orifice 74 and enters the third chamber 48. The fluids 103 and 109 combine in the third chamber 48, creating a fluid mixture 116 that exits the third port 18. With the needle element 26 in the position shown in FIG. 5, there is less space between the first portion 41 of the needle element and the inside face 63 of the orifice 64 of the first needle seat 60 than there is between the second portion 43 of the needle element and the inside face 73 of the orifice 74 of the second needle seat 70. Thus, assuming that the first fluid 103 is supplied through the first port 14 at approximately the same pressure as the second fluid 109 is supplied through the second port 16, the resultant mixture 116 of the two fluids will have a greater percentage content of the second fluid 109 than the first fluid 103. Depending on the design, varying flows from the first chamber to the third chamber may occur with the needle element in a position with the first end 40 most proximal the linear actuator 28. For example, with the needle element 26 in a position with the first end 40 most proximal the linear actuator 28, the first portion 41 may contact the inside face 63 of the orifice 64 of the first needle seat 60, thereby eliminating or nearly eliminating flow of the first fluid 103 from the first chamber 44 into the third chamber 48.

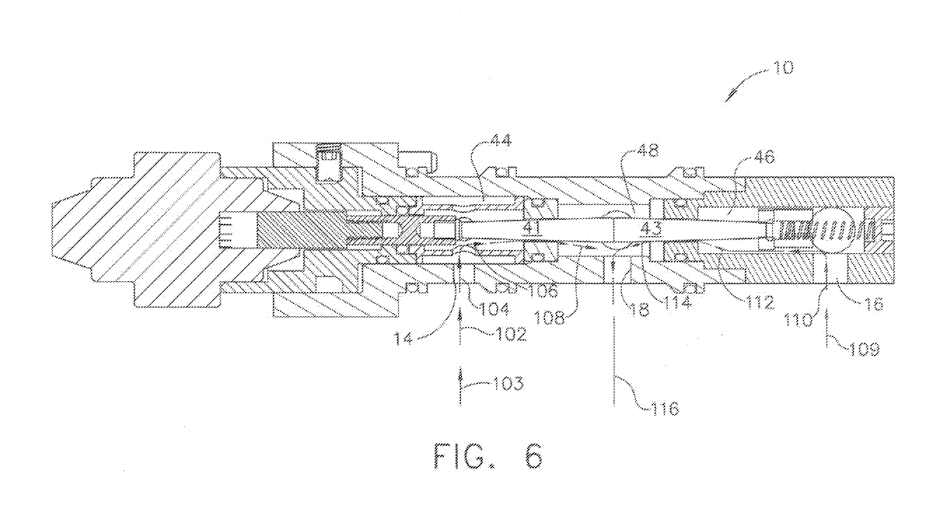

FIG. 6 shows the mixing valve 10 with the needle element 26 in a position with the first end 40 most distal the linear actuator 28. A first fluid 103 indicated by arrows 102, 104, 106, and 108 flows in a first port 14, enters the first chamber 44, and passes through the orifice 64 of the first needle seat 60 between the tapered first portion 41 of the needle element and the face 63 of the first orifice 64 and enters the third chamber 48. A second fluid 109 indicated by arrows 110, 112, and 114 passes through second port 16, enters the second chamber 46, and passes through the orifice 74 of the second needle seat 70 between the tapered portion 43 of the needle element and the inside face 73 of the second orifice 74 and enters the third chamber 48. The fluids 103 and 109 combine in the third chamber 48, creating a fluid mixture 116 that exits the third port 18. With the needle element 26 in the position shown in FIG. 6, there is more space between the first portion 41 of the needle element and the inside face 63 of the orifice 64 of the first needle seat 60 than there is between the second portion of the needle element and the inside face 73 of the orifice 74 of the second needle seat 70. Thus, assuming that the first fluid 103 is supplied through the first port 14 at approximately the same pressure as the second fluid 109 is supplied through the second port 16, the resultant mixture 116 of the two fluids will have a greater percentage content of the first fluid 103 than the second fluid 109. Depending on the design, varying flows from the second chamber to the third chamber may occur with the needle element in a position with the first end 40 most distal the linear actuator 28. For example, with the needle element 26 in a position with the first end 40 most distal the linear actuator 28, the second portion 43 may contact the inside face 73 of the orifice 74 of the first needle seat 70, thereby eliminating or nearly eliminating flow of the second fluid 109 from the second chamber 46 into the third chamber 48.

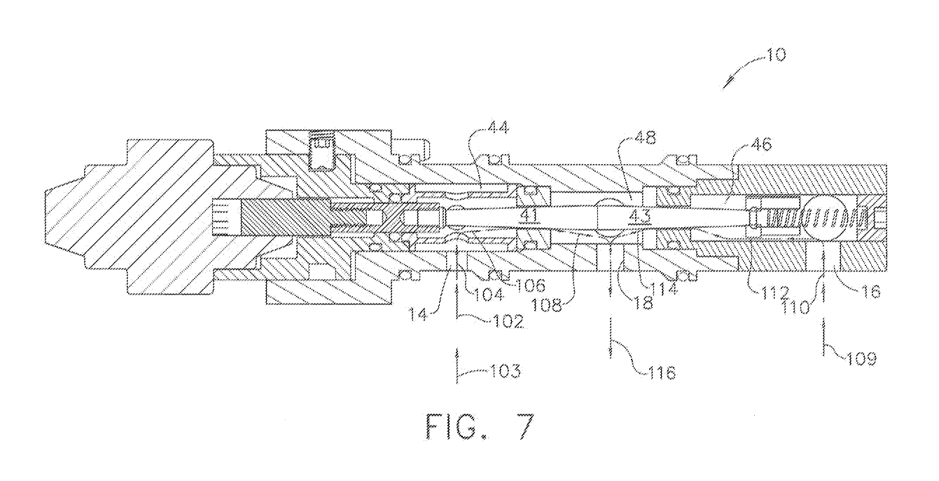

FIG. 7 shows the mixing valve 10 with the needle element 26 in a central position with the first end 40 between a position most distal the linear actuator 28 and a position most proximal the linear actuator 28. A first fluid 103 indicated by arrows 102, 104, 106, and 108 flows in a first port 14, enters the first chamber 44, and passes through the orifice 64 of the first needle seat 60 between the tapered first portion 41 of the needle element and the face 63 of the first orifice 64 and enters the third chamber 48. A second fluid 109 indicated by arrows 110, 112, and 114 passes through second port 16, enters the second chamber 46, and passes through the orifice 74 of the second needle seat 70 between the tapered portion 43 of the needle element and the face 73 of the second orifice 74 and enters the third chamber 48. The fluids 103 and 109 combine in the third chamber 48, creating a fluid mixture 116 that exits the third port 18. With the needle element 26 in the position shown in FIG. 7, the space between the first portion 41 of the needle element and the inside face 63 of the orifice 64 of the first needle seat 60 is about equal to the space between the second portion of the needle element and the inside face 73 of the orifice 74 of the second needle seat 70. Thus, assuming that the first fluid 103 is supplied through the first port 14 at approximately the same pressure as the second fluid 109 is supplied through the port 16, the resultant mixture 116 of the two fluids will have about an equal amount of the second fluid 109 as the first fluid 103.

The linear actuator 28 moves the needle element between a position with the first end 40 of the needle element 26 most proximal the linear actuator 28, as shown in FIG. 5, and a position with the first end 40 of the needle element 26 most distal the linear actuator 28 as shown in FIG. 6. Depending on the mix desired, the linear actuator 28 can locate the needle valve 26 in any one of a plurality of positions between the position with the first end 40 of the needle element 26 most proximal the linear actuator 28, as shown in FIG. 5, and a position with the first end 40 of the needle element 26 most distal the linear actuator 28 as shown in FIG. 6. The linear actuator 28 is typically controlled by a microprocessor that drives the needle element to a specified position depending on the percentage of the first fluid 103 and the percentage of the second fluid 109 required in the mixture 116. Additionally, the linear actuator 28 may include a feedback mechanism to provide feedback to the microprocessor regarding the position of the needle element.

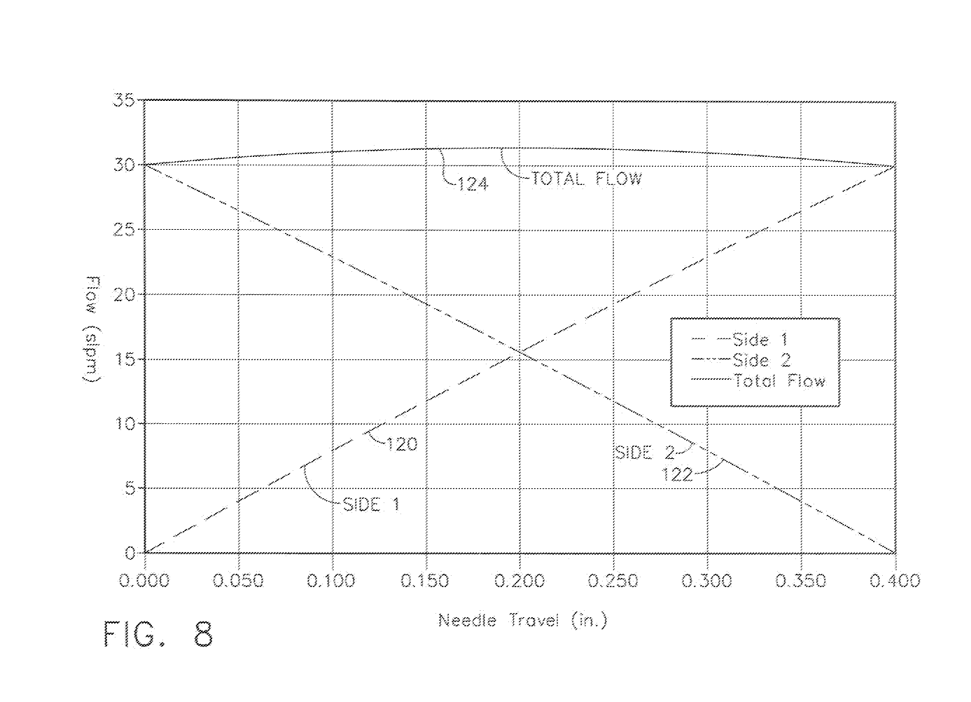

FIG. 8 is a graph showing an exemplar flow profile of a mixing valve. An upwardly sloping line 120 shows the amount of fluid flowing in the first port 14, to the first chamber 44, through the orifice 64, and into the third chamber 48 at various locations of the needle element. A downwardly sloping line 122 shows the amount of fluid flowing in the second port 16, to the second chamber 46, through the orifice 74, and into the third chamber 48. A line 124 shows the resultant flow of the mixed fluid 116 flowing out of the third chamber 48 through port 18. The 0.000 on the x-axis represents the position where the first end 40 of the needle element 26 is most proximal the linear actuator 28, as shown in FIG. 5. The 0.400 on the x axis represents a position with the first end 40 of the needle element 26 most distal the linear actuator 28 as shown in FIG. 6. As shown on the graph, as the needle element 26 moves from a most proximal position to a most distal position, the flow of the first fluid 103 through a first port 14 increases and the flow of the second fluid 109 through the second port 16 decreases, thereby increasing the percentage of the first fluid 103 and decreasing the percentage of the second fluid 109 in the mixture. While FIG. 8 depicts one exemplar flow profile, other flow profiles, including those with non-linear flow lines for the lines 120 and 122, and higher and lower flows may also be provided with the embodiment described herein. The flows can be changed by increasing or decreasing the pressures of fluids 103 and 109, changing the shape of the needle element 26, changing the size of the orifices 64 and 74, and other changes to the geometry of the mixing valve components.

Various types of fluids may be mixed with the mixing valve. For example, the first fluid 103 may be oxygen and the second fluid 109 may be air. In that example, the resultant mixture 116 is oxygen enriched air. In the flow chart shown in FIG. 8, if the needle element 26 were at 0.100, then the mixture 116 would include approximately 8 liters per minute of oxygen (not including the oxygen in the standard air) and approximately 23 liters per minute of standard air.

A set screw 301 may be used to hold the linear actuator 28 in the body 12.

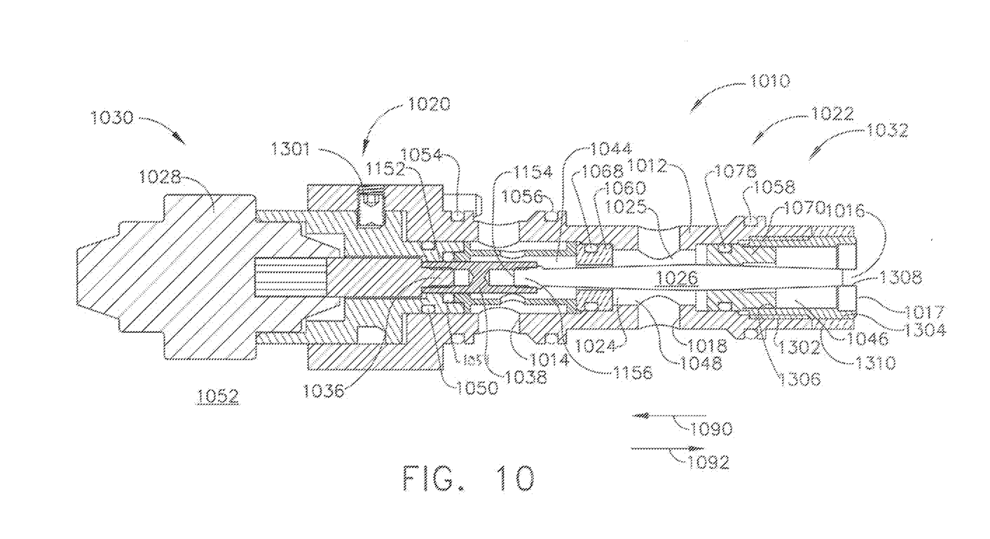

FIG. 10 shows an embodiment of a mixing valve 1010 having a one-piece needle element 1026. The mixing valve 1010 has a first end 1030 and a second end 1032, a body 1012 having a first port 1014, a second port 1016, and a third port 1018. The body 1012 has a first end 1020 and a second end 1022. The body 1012 has a centrally located valve chamber 1024 that communicates with the first port 1014, the second port 1016, and the third port 1018. The valve chamber 1024 receives the needle element 1026. While the second port 1016 is shown in an end 1017 of the body 1012, it may also be located between a seal 1058 and the end 1017. Typically, the valve chamber is cylindrical, as is the needle element, but the valve chamber and needle element may be other shapes also. The body 1012 shown in FIG. 10 is for a cartridge type of mixing valve, which would be inserted into a cavity in a valve block (not shown) known to those in the art. Seals 1054, 1056, and 1058 seal the valve body 1012 against the cavity walls of the valve block. Other types of valves, such as ported or manifold valves, may also be made using the embodiment described herein. The mixing valve can be used to mix various types of fluids, such as liquids or gases.

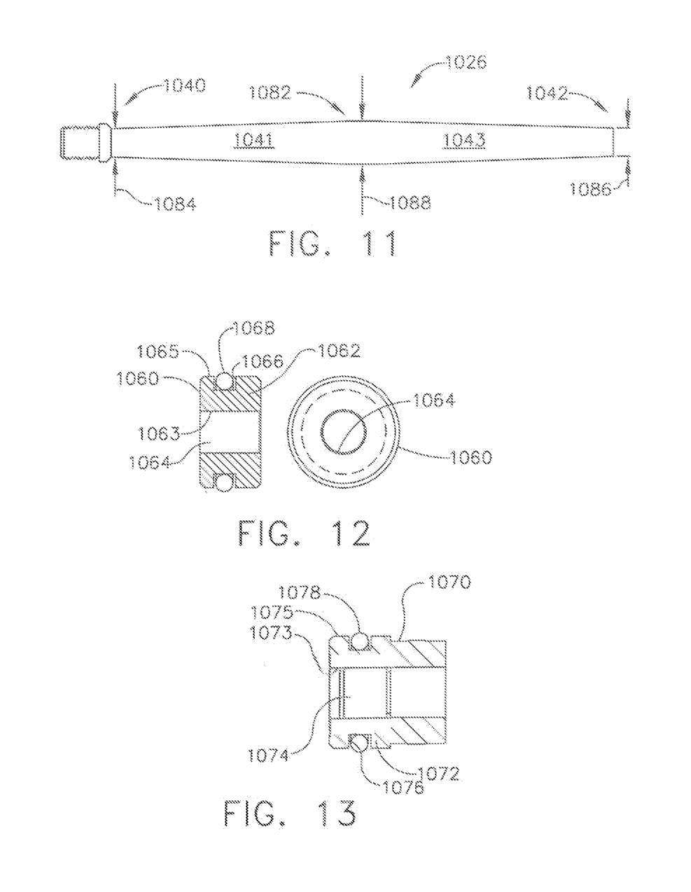

FIG. 11 shows an enlarged view of the needle element 1026 which is a substantially rigid needle element which may be made from a single piece or from multiple pieces affixed together to form a rigid needle element. With a rigid needle element, instead of the previously described embodiment where the first and second portions 41 and 43 may be loosely joined, the spring 80 is not required to bias the needle element against the linear actuator. Instead, the linear actuator moves the entire rigid needle element in the directions of arrows 1090 and 1092 (FIG. 10) as needed. The needle element has a first end 1040, a second end 1042, a tapered first portion 1041, a tapered second portion 1043, and a central section 1082. The first end 1040 has a diameter 1084, the second end 1042 has a diameter 1086, and the central section 1082 has a diameter 1088. Typically, the diameter 1084 of the first end 1040 and the diameter 1086 of the second end 1042 are less than the diameter 1088 of the central section 1082. Thus, the needle element 1026 tapers from a larger diameter at the central section 1082 to a smaller diameter at the first end 1040 and the second end 1042. The first end 1040 is connected to a linear actuator, described later.

The mixing valve 1010 has a linear actuator 1028 mounted to the first end 1020 of the valve body 1012. In the one embodiment, the linear actuator is a stepper motor 1034 that drives a male threaded shaft 1036, but other types of linear actuators, such as servo motors, may be used. A coupling 1038 connects the shaft 1036 to the first end 1040 of the needle element. The coupling may include female threads 1152 for receiving the male threaded shaft 1036 of the linear actuator and female threads 1154 for receiving a male threaded shaft 1156 of the first end 1040 of the needle element 1026. Other methods for connecting the coupling to the linear actuator and the needle, such as a press fit, may also be used. Alternatively, the needle may be connected directly to the linear actuator. Seals 1050 and 1051 isolate the valve chamber 1024 from atmosphere 1052 to prevent fluid in the valve chamber 1024 from leaking into the atmosphere 1052. The linear actuator 1028 moves the needle in the direction of arrows 1090 and 1092 to a predetermined position, depending on the desired fluid mix, explained in greater detail later.

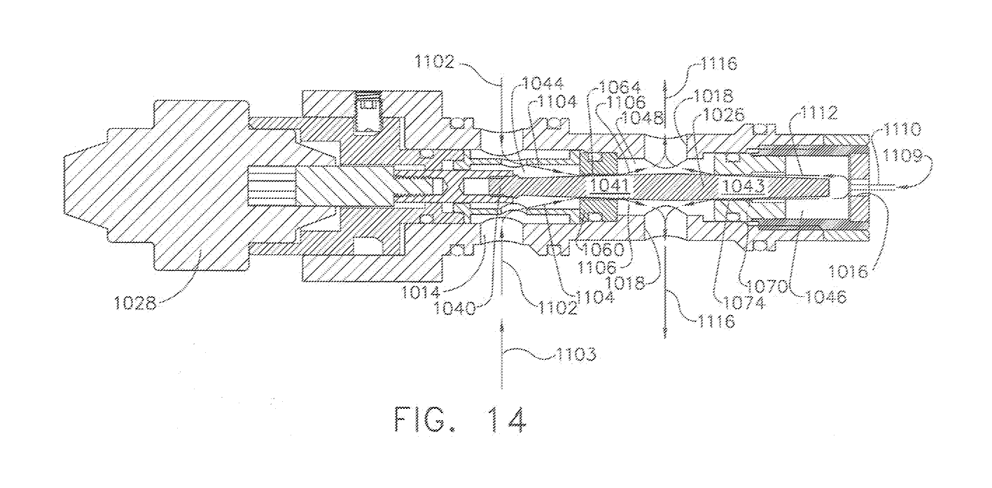

A first needle seat 1060 and a second needle seat 1070 are located in the valve chamber 1024. As shown in FIGS. 12 and 13, the needle seats 1060 and 1070 have ring sections 1062 and 1072, respectively, that define orifices 1064 and 1074, respectively. The orifices 1064 and 1074 have inside faces 1063 and 1073, respectively. Grooves 1066 and 1076 in outer faces 1065 and 1075 accommodate seals 1068 and 1078 for sealing the outer faces 1065 and 1075 against an outer surface 1025 of the valve chamber 1024. Location of the needle seats 1060 and 1070 in the valve chamber create a first chamber 1044, a second chamber 1046, and a third chamber 1048. The needle element 1026 passes through the orifices 1064 and 1074.

The second end 1022 of the body 1012 has female threads 1302 that receive a needle seat holder 1304 with male threads 1306. The second needle seat 1070 is disposed in the needle seat holder 1304. Typically the second needle seat 1070 is affixed in the needle seat holder 1304 by a press fit, adhesive, locking material, or other methods of affixing. The needle seat holder 1304 may include a tool receiver 1304 for receiving a tool, such as a slot for receiving a screwdriver. Using a tool in the tool receiver, the needle seat holder 1304 may be rotated and screwed in the body 1012 in the direction of arrow 1090 or out of the body in the direction of arrow 1092. By screwing the needle seat holder 1304 in or out, the second needle seat 1070 is also moved. By doing so, the valve can be tuned by changing the distance between the first needle seat 1060 and the second needle seat 1070. As such, the flow of a first fluid 1103 and a second fluid 1109 (described later) can be adjusted to predetermined values for a given location of the needle element 1026. Once the needle seat holder 1304 is in the desired position, a jam nut 1310 can be used to lock the needle seat holder 1304 in position.

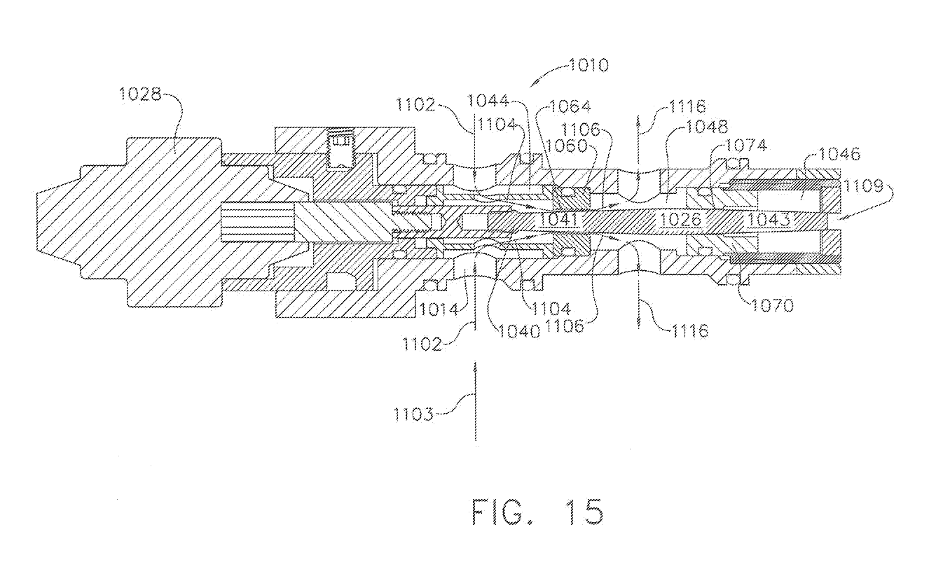

FIG. 14 shows the mixing valve 1010 with the needle element 1026 in a position with the first end 1040 most proximal the linear actuator 1028. A first fluid 1103 indicated by arrows 1102, 1104, and 1106 flows in a first port 1014, enters the first chamber 1044, and passes through the orifice 1064 of the first needle seat 1060 between the tapered first portion 1041 of the needle element and the inside face 1063 of the first orifice 1064 and enters the third chamber 1048. A second fluid 1109 indicated by arrows 1110 and 1112 passes through second port 1016, enters the second chamber 1046, and passes through the orifice 1074 of the second needle seat 1070 between the tapered portion 1043 of the needle element and the inside face 1073 of the second orifice 1074 and enters the third chamber 1048. The fluids 1103 and 1109 combine in the third chamber 1048, creating a fluid mixture 1116 that exits the third port 1018. With the needle element 1026 in the position shown in FIG. 14, there is less space between the first portion 1041 of the needle element and the inside face 1063 of the orifice 1064 of the first needle seat 1060 than there is between the second portion 1043 of the needle element and the inside face 1073 of the orifice 1074 of the second needle seat 1070. Thus, assuming that the first fluid 1103 is supplied through the first port 1014 at approximately the same pressure as the second fluid 1109 is supplied through the second port 1016, the resultant mixture 1116 of the two fluids will have a greater percentage content of the second fluid 1109 than the first fluid 1103. Depending on the design, varying flows from the first chamber to the third chamber may occur with the needle element in a position with the first end 1040 most proximal the linear actuator 1028. For example, with the needle element 1026 in a position with the first end 1040 most proximal the linear actuator 1028, the first portion 1041 may contact the inside face 1063 of the orifice 1064 of the first needle seat 1060, thereby eliminating or nearly eliminating flow of the first fluid 1103 from the first chamber 1044 into the third chamber 1048.

FIG. 15 shows the mixing valve 1010 with the needle element 1026 in a position with the first end 1040 most distal the linear actuator 1028. A first fluid 1103 indicated by arrows 1102, 1104, and 1106 flows in a first port 1014, enters the first chamber 1044, and passes through the orifice 1064 of the first needle seat 1060 between the tapered first portion 1041 of the needle element and the face 1063 of the first orifice 1064 and enters the third chamber 1048. With the needle element 1026 in a position with the first end 1040 most distal the linear actuator 1028, the second portion 1043 may contact the inside face 1073 of the orifice 1074 of the first needle seat 1070, thereby eliminating or nearly eliminating flow of the second fluid 1109 from the second chamber 1046 into the third chamber 1048. Thus, the resultant gas 1116 exiting the third chamber 1048 will typically contain a majority, if not contain solely, the gas 1103.

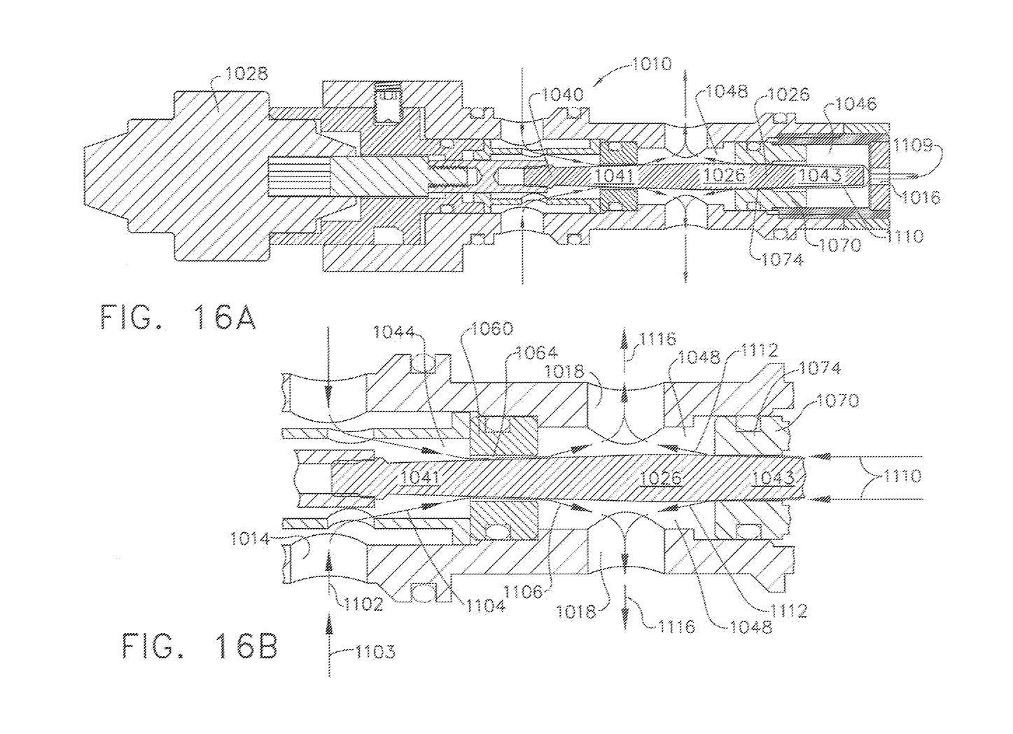

FIGS. 16A and 16B show the mixing valve 1010 with the needle element 1026 in a central position with the first end 1040 between a position most distal the linear actuator 1028 and a position most proximal the linear actuator 1028. A first fluid 1103 indicated by arrows 1102, 1104, and 1106 flows in the first port 1014, enters the first chamber 1044, and passes through the orifice 1064 of the first needle seat 1060 between the tapered first portion 1041 of the needle element and the face 1063 of the first orifice 1064 and enters the third chamber 1048. A second fluid 1109 indicated by arrows 1110 and 1112 passes through second port 1016, enters the second chamber 1046, and passes through the orifice 1074 of the second needle seat 1070 between the tapered portion 1043 of the needle element and the face 1073 of the second orifice 1074 and enters the third chamber 1048. The fluids 1103 and 1109 combine in the third chamber 1048, creating a fluid mixture 1116 that exits the third port 1018. With the needle element 1026 in the position shown in FIGS. 16A and 16B, the space between the first portion 1041 of the needle element and the inside face 1063 of the orifice 1064 of the first needle seat 1060 is about equal to the space between the second portion of the needle element and the inside face 1073 of the orifice 1074 of the second needle seat 1070. Thus, assuming that the first fluid 1103 is supplied through the first port 1014 at approximately the same pressure as the second fluid 1109 is supplied through the port 1016, the resultant mixture 1116 of the two fluids will have about an equal amount of the second fluid 1109 as the first fluid 1103.

The linear actuator 1028 moves the needle element between a position with the first end 1040 of the needle element 1026 most proximal the linear actuator 1028, as shown in FIG. 14, and a position with the first end 1040 of the needle element 1026 most distal the linear actuator 1028 as shown in FIG. 15. Depending on the mix desired, the linear actuator 1028 can locate the needle valve 1026 in any one of a plurality of positions between the position with the first end 1040 of the needle element 1026 most proximal the linear actuator 1028, as shown in FIG. 14, and a position with the first end 1040 of the needle element 1026 most distal the linear actuator 1028 as shown in FIG. 15. The linear actuator 1028 is typically controlled by a microprocessor that drives the needle element to a specified position depending on the percentage of the first fluid 1103 and the percentage of the second fluid 1109 required in the mixture 1116. Additionally, the linear actuator 1028 may include a feedback mechanism to provide feedback to the microprocessor regarding the position of the needle element.

The graph of FIG. 8 is also exemplar of the flow from the mixing valve 1010. Various types of fluids may be mixed with the mixing valve. For example, the first fluid 1103 may be oxygen and the second fluid 1109 may be air. In that example, the resultant mixture 1116 is oxygen enriched air. In the flow chart shown in FIG. 8, if the needle element 1026 were at 0.100, then the mixture 1116 would include approximately 8 liters per minute of oxygen (not including the oxygen in the standard air) and approximately 23 liters per minute of standard air.

A set screw 1301 may be used to hold the linear actuator 1028 in the body 1012.

While the embodiments above describes a mixing valve capable of mixing two fluids, one of ordinary skill in the art could modify the mixing valve, such as by the addition of another needle element and needle seat, to mix three or more fluids. Additionally, the linear actuator may also be a manually operated linear actuator. One example of a linear actuator is a screw that moves the needle element when rotated.

While the present invention has been illustrated by the description of embodiments thereof, and while the embodiments have been described in considerable detail, it is not intended to restrict or in any way limit the scope of the appended claims to such detail. Additional advantages and modifications will be readily apparent to those skilled in the art. The invention is therefore not limited to the specific details, representative apparatus and method, and illustrated examples shown and described. Accordingly, departures may be made from such details without departing from the scope or spirit of the invention.

What is claimed is:

1. A mixing valve comprising:
a. a valve body having a first end, a second end, and defining a valve chamber between the first end and the second end,
b. a needle element disposed in the valve chamber,
c. a linear actuator connected to the needle element,
d. a first port communicating with the valve chamber for receiving a first fluid,
e. a second port communicating with the valve chamber for receiving a second fluid, and
f. a third port communicating with the valve chamber for dispensing a mixture containing at least some of the first fluid and at least some of the second fluid.

2. The mixing valve according to claim 1, wherein the linear actuator is a stepper motor with a screw.

3. The mixing valve according to claim 1, wherein the needle element has a first end, a tapered first portion, a central section, a tapered second portion, and a second end.

4. The mixing valve according to claim 3, further comprising a first needle seat disposed in the valve chamber, wherein the first needle seat defines a first orifice and the tapered first portion of the needle element passes through the first orifice.

5. The mixing valve according to claim 4, further comprising a second needle seat disposed in the valve chamber, wherein the second needle seat defines a second orifice and the tapered second portion of the needle element passes through the second orifice.

6. The mixing valve according to claim 5, wherein the first port is located between the central section of the needle element and the first end of the needle element.

7. The mixing valve according to claim 5, wherein the third port is located between the first end of the needle element and the second end of the needle element.

8. The mixing valve according to claim 5, wherein the first needle seat is located between the first port and the third port.

9. The mixing valve according to claim 8, wherein the second needle seat is located between the second port and the third port.

10. A mixing valve comprising:
a. a valve body having a first end, a second end, and defining a valve chamber between the first end and the second end, wherein the valve chamber has a first chamber, a second chamber, and a third chamber,
b. a needle element disposed in the valve chamber,
c. a linear actuator connected to the needle element,
d. a first needle seat disposed between the first and third chamber,
e. a second needle seat disposed between the second and third chamber,
f. a first port communicating with the first chamber for receiving a first fluid,
g. a second port communicating with the second chamber for receiving a second fluid, and
h. a third port communicating with the third chamber for dispensing a mixture containing at least some of the first fluid and at least some of the second fluid.

11. The mixing valve according to claim 10, wherein the linear actuator is a stepper motor with a screw.

12. The mixing valve according to claim 10, wherein the needle element has a first end, a tapered first portion, a central section, a tapered second portion, and a second end.

13. The mixing valve according to claim 12, wherein the first needle seat defines a first orifice and the tapered first portion of the needle element passes through the first orifice.

14. The mixing valve according to claim 13, wherein the second needle seat defines a second orifice and the tapered second portion of the needle element passes through the second orifice.

15. The mixing valve according to claim 14, wherein the first port is located between the central section of the needle element and the first end of the needle element.

16. The mixing valve according to claim 14, wherein the third port is located between the first end of the needle element and the second end of the needle element.

17. The mixing valve according to claim 14, wherein the first needle seat is located between the first port and the third port.

18. The mixing valve according to claim 17, wherein the second needle seat is located between the second port and the third port.
